(19) United States
(12) Patent Application Publication
(10) Pub. No.: US 2020/0027138 A1
(43) Pub. Date: Jan. 23, 2020

(54) LOST AND FOUND MANAGEMENT SYSTEMS AND METHODS

(71) Applicant: Mastercard International Incorporated, Purchase, NY (US)

(72) Inventors: Navneet Jain, Pune (IN); Piyush Sharma, Pune (IN); Dipali Tripathi, Lucknow (IN); Puneet Gandhi, Pune (IN)

(73) Assignee: Mastercard International Incorporated, Purchase, NY (US)

(21) Appl. No.: 16/513,900

(22) Filed: Jul. 17, 2019

(30) Foreign Application Priority Data
Jul. 19, 2018 (SG) 10201806198U

(51) Int. Cl. G06Q 30/02; G06Q 20/40

(52) U.S. Cl. CPC G06Q 30/0281; G06Q 30/0208; G06Q 20/409

(57) ABSTRACT

Embodiments provide a lost and found management method for payment cards. The method includes receiving, by a server system associated with a payment network, one or more attributes of a payment card of a first party from a second party who found the payment card. The one or more attributes are sent by the second party through an application interface associated with the server system. The method includes facilitating validation, by the server system, of the one or more attributes. The method further includes, upon successful validation, accessing, by the server system, information of an issuer bank of the payment card. The method further includes facilitating sending, by the server system, a notification to the issuer bank of a lost and found status of the payment card.

### CROSS REFERENCE TO RELATED APPLICATIONS

This application claims priority to Singaporean Application Serial No. 10201806198U, filed Jul. 19, 2018, which is incorporated herein by reference in its entirety

### TECHNICAL FIELD

The present disclosure relates to lost and found management systems and methods and, more particularly to, facilitating return of lost and found payment cards and other identity documents in wallets.

### BACKGROUND

People carry wallets with them whenever they step outside of their homes. The wallets may contain various cards, such as payment cards, loyalty cards, identity cards, business cards, other documents that fit in the wallet, cash, coins, etc. It is not so uncommon scenario that entire wallet or specific content of the wallet are often misplaced or lost.

When a wallet is lost, there are very little chances that the content of the wallet will be easily retrieved. The content of a wallet may include important documents such as one or more identity cards (e.g. PAN card, driving license, passport, Aadhar card, etc.), one or more payment cards, cash, etc. Lost identity cards and payment cards can be misused by unauthorized sources for committing frauds. As such, loss of these documents may be reported to the relevant authority.

Further, it is cumbersome for a user to report a loss of the identity cards and payment cards. For instance, if both of a permanent account number (PAN) and an election ID card are lost, the user may have to report a loss of the PAN card to its respective agency issuing the PAN card and have to report the loss of the election ID card to the organization managing issuance of election ID cards. Subsequently, the user has to apply for new identity cards. Similarly, for payment cards, the user may have to report the loss of payment cards, request an issuing bank to block usage of the lost payment cards and apply for new payment cards. The process of reporting the loss and getting new identity cards and payment cards consumes effort, time and money.

Furthermore, when the lost wallet and the content of the lost wallet are found by an individual who wants to return it to the owner, the individual has no proper channel to reach the owner. Currently, in some instances, people make use of social media platforms and print media channels which are not effective ways to get in touch with the owners. Another way is to hand over the lost items to an authority, such as a bank or security agencies, associated with one of the lost items. The individual who finds the lost items may have to put in an effort and to bear the cost of traveling to the concerned authorities to return the lost items with no assurance that the lost items will be handed over to the owner.

Hence, in light of the foregoing discussion, it is needed to implement a lost and found management system and method, wherein lost and found items can be easily reported by owners and returned to the owners by finders in a hassle-free manner.

### SUMMARY

Various example embodiments of the present disclosure provide methods, systems, user devices and computer program products for management of lost and found items. Various embodiments also provide a server system facilitating an application that can be used to manage lost and found items, such as payment cards and identity documents.

An embodiment provides a lost and found management method for payment cards. The method includes receiving, by a server system associated with a payment network, one or more attributes of a payment card of a first party from a second party who found the payment card. The one or more attributes are sent by the second party through an application interface associated with the server system. The method includes facilitating validation, by the server system, of the one or more attributes. The method further includes, upon successful validation, accessing, by the server system, information of an issuer bank of the payment card. The method further includes facilitating sending, by the server system, a notification to the issuer bank of a lost and found status of the payment card.

Another embodiment provides a lost and found management system. The system includes a memory comprising stored instructions and a process. The processor is configured to execute the stored instructions and thereby cause the lost and found management system to perform receiving one or more attributes of an identity document of a first party from a second party who found the identity document. The one or more attributes are sent by the second party through an application interface associated with a server system. The lost and found management system is further caused to facilitate validation of the one or more attributes. The lost and found management system is further caused to access information of an issuer bank of the identity document upon successful validation. The lost and found management system is further caused to facilitate sending a notification to the issuer bank of a lost and found status of the identity document.

Another embodiment provides a lost and found management method for payment cards. The method includes facilitating, by the server system, an application interface to each of a first party and a second party. The application interface is facilitated to the first party through a first issuer server associated with a payment card of the first party, and the application interface is facilitated to the second party through a second issuer server associated with a payment card of the second party. The method further includes receiving, by the server system, a photograph of a payment card of the first party sent by the second party. The first party has lost the payment card of the first party and the second party has found the payment card of the first party. The photograph is sent using the application interface installed on a user device of the second party. The method further includes identifying, by the server system, whether the photograph of the payment card conforms to one or more pre-defined formats by comparing the photograph against the one or more pre-defined formats. The method further includes electronically identifying, by the server system, a card number or a name of an issuer bank of the payment card from the photograph. Thereafter, the method includes accessing, by the server system, a Bank Identification Number (BIN) database to obtain an address of the issuer bank based on the card number or the name of the issuer bank. The method further includes facilitating, by the server system, generation of a printable document containing the address of the issuer bank for sending the payment card to the issuer bank in an envelope containing the printable document. Thereafter, the method include sending, by the server system, a notification of the printable document to the application interface of the first party and to the application interface of the second party.

### BRIEF DESCRIPTION OF THE FIGURES

For a more complete understanding of example embodiments of the present technology, reference is now made to the following descriptions taken in connection with the accompanying drawings in which:

FIG. 1 is an illustration of an example environment, in which at least some example embodiments of the present disclosure can be implemented;

FIG. 2 includes a simplified schematic flow diagram representing a method of facilitating returning a lost payment card, to an issuer bank of the payment card by a finder, in accordance with an example embodiment of the present disclosure;

FIGS. 3A and 3B are example representations of pages of an application interface of the lost and found application provided on a second party device, in accordance with an example embodiment of the present disclosure;

FIGS. 4A and 4B illustrate a simplified schematic flow representing another method of facilitating returning a lost payment card to an issuer bank/an owner of the lost payment card by the finder, in accordance with an example embodiment of the present disclosure;

FIGS. 5A-5C are example representations of pages of an application interface of the lost and found application presented on a first party device, in accordance with an example embodiment of the present disclosure;

FIGS. 5D-5F are example representations of pages of the application interface of the lost and found application presented on the second party device, in accordance with an example embodiment of the present disclosure;

FIGS. 6A and 6B illustrate a simplified schematic flow diagram representing a method of facilitating returning a lost identity document to an issuer bank/an owner of the lost identity document by a finder, in accordance with an example embodiment of the present disclosure;

FIGS. 7A, 7B and 7C illustrate flow diagrams of methods for facilitating returning a lost payment card to an issuer bank/an owner of the lost payment card by a finder, in accordance with some example embodiments of the present disclosure;

FIG. 8 is a simplified block diagram of a server system, in accordance with one embodiment of the present disclosure;

FIG. 9 is a simplified block diagram of an issuer server used for facilitating returning a lost payment card, to an issuer bank/an owner of the lost payment card by a finder, in accordance with one embodiment of the present disclosure;

FIG. 10 is a simplified block diagram of a payment server used for facilitating returning a lost payment card, to an issuer bank/an owner of the lost payment card by a finder, in accordance with one embodiment of the present disclosure; and

FIG. 11 shows simplified block diagram of a user device, such as the first party device and the second party device, in accordance with one embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “issuer account” used throughout the description refers to a financial account that is used to fund the financial transaction (interchangeably referred to as “payment transaction”). Examples of the issuer account include, but are not limited to a savings account, a credit account, a checking account and a virtual payment account. Each of the issuer account and the acquirer account may be associated with an entity such as an individual person, a family, a commercial entity, a company, a corporation, a governmental entity, a non-profit organization and the like. In some scenarios, an issuer or acquirer account may be a virtual or temporary payment account that can be mapped or linked to a primary payment account, such as those accounts managed by PayPal®, and the like.

The term “payment card”, used throughout the description, refer to a physical or virtual card linked with a financial or payment account that may be presented to a merchant or any such facility in order to fund a financial transaction via the associated payment account. Examples of the payment card include, but are not limited to, debit cards, credit cards, prepaid cards, digital wallet, virtual payment numbers, virtual card numbers, forex card, charge cards and stored-value cards. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account.

### Overview

Various example embodiments of the present disclosure provide methods, systems, user devices and computer program products for management of lost and found items. Various embodiments also provide a server system facilitating an application that can be used to manage lost and found items, such as payment cards and identity documents.

In various example embodiments, the present disclosure provides a lost and found application associated with a server system. The server system includes one or more of a payment server associated with a payment network, a first issuer server associated with an owner of a payment card which is lost and a second issuer server associated with a finder of the owner's lost payment card. The lost and found application is managed by the payment server and can be accessed on various devices, such as mobile phones. Alternatively, the lost and found application may be managed by the first issuer server and/or the second issuer server. The lost and found application may be a mobile application and/or a desktop application. The owner of a payment card reports the loss of the payment card in an application interface of the lost and found application. To report the loss, the owner may enter one or more attributes of the lost payment card. A finder of the wallet of the owner may also access the lost and found application associated with the server system on his respective device to enter one or more attributes of the payment card. Some examples of the attributes may include card number, name of card holder, issuing authority (such as bank), etc. The attributes may be manually entered in the lost and found application. Alternatively, the attributes may include a photograph of the payment card. The finder may also provide finder details, such as, finder name, bank account details, contact information etc., in the lost and found application. The server system validates the attributes and accesses information of an issuer bank of the lost payment card. The server system further validates the attributes received in the lost and found application entered by the finder and forwards the information to the corresponding issuer bank of the owner.

In an embodiment, the issuer bank of the owner forwards a copy of an address document (such as a PDF image) comprising an address of the issuer bank of the owner. The finder may be presented with a printable format of the address of the issuer bank within the lost and found application. The finder may get a print out (hard copy) of the address document and paste it on an envelope and post it to the address mentioned in the address document. The issuer bank of the owner may hand over the lost content to the owner upon reception. In at least one embodiment, provisions of rewarding the finder may be implemented, and the reward may be directly credited to the finder's bank account via a payment server associated with the payment network from the bank account of owner of the lost item.

In another embodiment, even if the owner of the lost item does not report to the corresponding issuer bank, the lost and found management can be initiated from the end of the finder of the lost item. For instance, once the finder provides information of the lost item in the lost and found application, a notification is sent to the issuer bank of a lost and found status of the payment card. The server system updates the lost and found status of the payment card in the lost and found application. Additionally, notification of the lost and found status of the payment card is sent to an owner device via the payment server. Further, the server system facilitates sending the finder details to the owner device. The owner device sends an acknowledgement to the server system in response to the notification. The server system notifies the finder of the acknowledgement on a finder device.

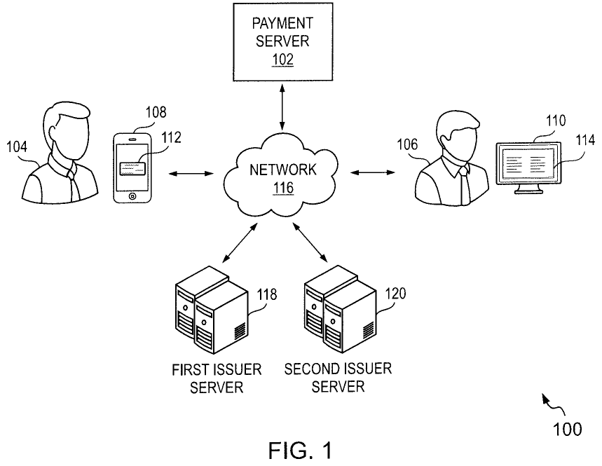

FIG. 1 illustrates an exemplary representation of an environment 100, in which at least some example embodiments of the present disclosure can be implemented. In the illustrated environment 100, a lost and found management system is illustrated. The lost and found management system includes a server system represented by a payment server 102, a first issuer server 118 and a second issuer server 120. It is to be noted that the server system can take examples of at least one of the first issuer server 118, the second issuer server 120 and the payment server 102. In at least one embodiment, the payment server 102, the first issuer server 118, the second issuer server 120 can be examples of logical servers built on cloud computing platform. Alternatively, these servers can be physical servers located at facilities of entities managing these servers.

In an embodiment, the payment server 102 manages a lost and found application. The API and other components of the lost and found application rests on the payment server 102. The lost and found application can be made available at application stores such as Google Play managed by Google®, Apple App store managed by Apple®, etc., and are downloadable from the application stores to be accessed on devices such as a first party device 108 associated with a first party 104 and a second party device 110 associated with a second party 106. The lost and found application is a set of computer executable codes configured to perform the method disclosed herein. The set of computer executable codes may be stored in a non-transitory computer-readable medium of the first party device 108 and the second party device 110. The lost and found application installed on the first party device 108 and the second party device 110 facilitates application interfaces 112 and 114 in the first party device 108 and the second party device 110, respectively, to enable communication with the payment server 102 and other servers such as the first issuer server 118 and the second issuer server 120.

In another embodiment, each of the first issuer server 118 and the second issuer server 120 manages the lost and found application. The API and other components of the lost and found applications rest on the servers 118 and 120. The lost and found application, as earlier described, is accessed at the first party device 108 associated with the first party 104 and the second party device 110 associated with the second party 106. The lost and found application installed on the first party device 108 facilitates the application interfaces 112 in the first party device 108 to enable communication with the first issuer server 118. Likewise, the lost and found application installed on the second party device 110 facilitates the application interface 114 in the second party device 110 to enable communication with the second issuer server 120. The lost and found application can be a mobile application and/or a desktop application, or can simply be a web application. In some scenarios, the lost and found application can be integrated with online banking interfaces, mobile banking interfaces of the users such as the first party 104 and the second party 106.

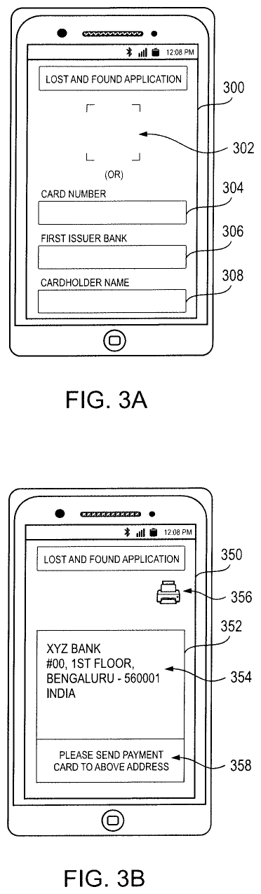

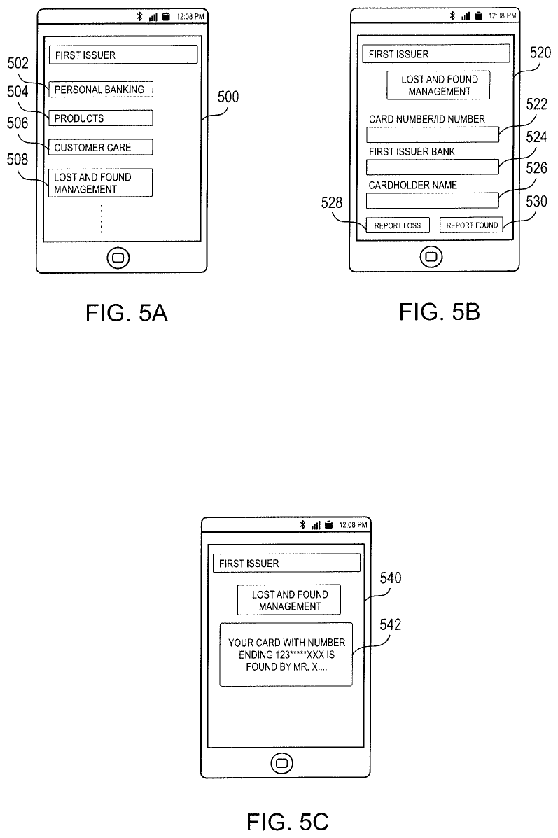

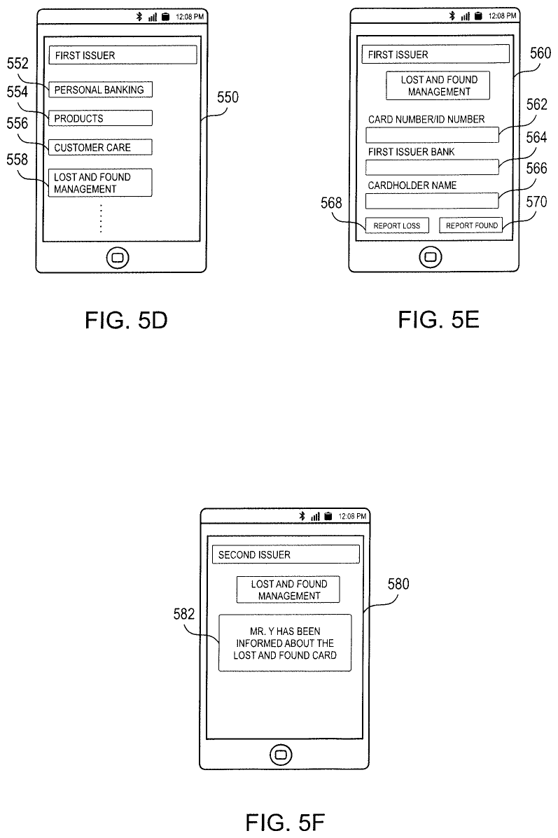

The first party 104 is an owner of one or more payment cards and one or more identity documents present inside a wallet. The first party 104 may have lost the wallet and the first party 104 wishes to report the loss of the wallet. The first party 104 enters one or more attributes of at least one of the payment cards or at least one of the identity documents present inside the wallet in the application interface 112 of the lost and found application. Attribute(s) can include one or more sections/fields of information such a card number, an issuer bank name, name of cardholder, etc. Some examples of the attributes are described with reference to FIGS. 3A, 5B and 5E. It must be noted that the terms ‘first party’ and ‘owner’ have been used interchangeably throughout the disclosure.

Examples of the first party device 108 include, but are not limited to, a smartphone, a tablet, a personal digital assistant (PDA), a notebook, etc. As an example, the first party device 108 of FIG. 1 is depicted as a smartphone. However, it shall be understood that, the first party device 108 is not limited to a smartphone and can include any electronic devices of the likes of a smartphone and having the capability to allow installation or access of third party applications and communicate with other devices via a network 116. It must be noted that the terms ‘first party device’ and ‘owner device’ have been used interchangeably throughout the disclosure.

The second party 106 is a finder of the wallet or the one or more payment cards and the one or more identity documents present inside the wallet lost by the first party 104. The second party 106 may wish to return the lost wallet or the one or more payment cards and the one or more identity documents present inside the wallet to the first party 104. For doing so, the second party 106 accesses the lost and found application on the second party device 110. The second party 106 enters one or more attributes of at least one of the payment cards or at least one of the identity documents present inside the wallet in the application interface 114 of the lost and found application. Examples of the second party device 110 include, but are not limited to, a personal computer (PC), a tablet device, a personal digital assistant (PDA), a smart phone and a laptop. In FIG. 1, the second party device 110 is depicted as a desktop computer. It must be noted that the terms ‘second party’ and ‘finder’ have been used interchangeably throughout the disclosure. It must further be noted that the terms ‘second party device’ and ‘finder device’ have been used interchangeably throughout the disclosure

The first issuer server 118 is associated with a financial institution normally called as an “issuer bank” or “issuing bank” or simply “issuer” or simply “bank”, in which the first party 104 may have an issuer account. In this disclosure, the first issuer server 118 is associated with a first issuer bank, in which the first party 104 has an issuer account and which has issued a payment card to the first party 104. The first issuer server 118 is further responsible for managing information of the first party 104. The first issuer server 118 includes an issuer database (not shown) for maintaining information such as one or more issuer accounts of the first party 104, transaction history related information, permanent account number (PAN) with which the one or more issuer accounts are linked, etc.

The second issuer server 120 is associated with a financial institution normally called as an “issuer bank” or “issuing bank” or simply “issuer” or simply “bank”, in which the second party 106 may have an issuer account. In this disclosure, the second issuer server 120 is associated with a second issuer bank, in which the second party 106 has an issuer account and which has issued a payment card to the second party 106. The second issuer server 120 is further responsible for managing user information of the second party 106. The second issuer server 120 includes an issuer database (not shown) for maintaining information such as one or more issuer accounts of the second party 106, transaction history related information, permanent account number (PAN) with which the one or more issuer accounts are linked, etc.

In one embodiment, the payment server 102 is, as an example a server managed by payment cards issuing authorities as a payment interchange network (not shown). Examples of payment interchange network include, but are not limited to, Mastercard® payment system interchange network. The Mastercard® payment system interchange network is a proprietary communications standard promulgated by Mastercard® International Incorporated for the exchange of financial transaction data between financial institutions that are members of Mastercard® International Incorporated. (Mastercard is a registered trademark of Mastercard International Incorporated located in Purchase, N.Y.).

The first party device 108, the second party device 110 and the server system communicate with one another via the communication network 116. The communication network 116 may be a centralized network or may comprise a plurality of sub-networks that may offer a direct communication or may offer indirect communication between the first party device 108, the second party device 110 and the server system. Examples of the communication network 116 include wireless networks, wired networks, and/or combinations thereof. Some non-exhaustive examples of the wireless networks may include wireless local area networks (WLANs), Bluetooth or Zigbee networks, cellular networks and the like. Some non-exhaustive examples of wired networks may include Local Area Networks (LANs), Ethernet, fiber optic networks and the like. An example of a combination of wired networks and wireless networks may include the Internet.

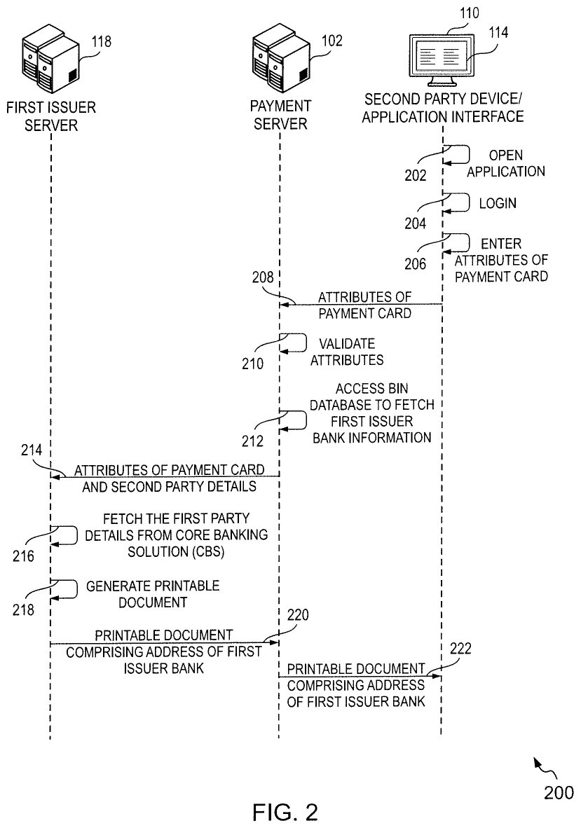

In an example scenario, it is assumed that the first party 104 has lost a payment card. The second party 106, who finds the lost payment card of the first party 104, accesses the lost and found application on the second party device 110 with objective to return the payment card to a first issuer bank of the payment card. A non-exhaustive example embodiment of facilitating returning of lost items, and more particularly a payment card, to the first issuer bank associated with the payment card, is described with reference to FIG. 2.

FIG. 2 includes a simplified schematic flow diagram 200 representing a method of facilitating returning a lost payment card to an issuer bank of the payment card by a second party, such as the second party 106, in accordance with an example embodiment of the present disclosure.

The lost and found application may be hosted by the payment server 102. It shall be noted that the lost and found application is downloaded and installed at the second party device 110. The second party 106 can download the lost and found application at any instant before or after finding the lost payment card of the first party 104.

At 202, the second party 106 opens the lost and found application on the second party device 110.

At 204, the second party 106 logs into the lost and found application. Logging in can be done with an existing account or by creating a new account for the lost and found application. Details related to sign in is not explained herein for the sake of brevity. Once logged in, the second party 106 can view the application interface 114 on the second party device 110.

At 206, the second party 106 enters one or more attributes of the payment card of the first party 104 in the second party device 110. The application interface 114 provides options to fill in attributes (e.g. card number, issuer bank name and cardholder's name). In some embodiments, the attribute may include a photograph of the payment card. The second party 106, using his device 110, can click a photograph of the payment card and upload the photograph in the application interface 114. Additionally, the second party 106 enters second party details such as finder's name, address, contact information and an issuer account number of the second party 106 in the finder device 110.

At 208, the one or more attributes are sent to the payment server 102 by the lost and found application. At 210, the one or more attributes are validated. Validation, herein, may refer to determining if the attributes are valid and are associated with a cardholder (such as the first party/owner 104). Validation, may further refer to identifying whether the photograph belongs to the payment card and conforms of a pre-defined dimension, shape and format or not.

At 212, the payment server 102 accesses a Bank Identification Number (BIN) database (not shown in Figures) to fetch information on the first issuer bank. The BIN database includes information corresponding to a plurality of banks including the first issuer bank managing the first issuer server 118 and associated with the first party 104 and the second issuer bank managing the second issuer server 120 and associated with the second party 106.

At 214, the one or more attributes are sent to the first issuer server 118 by the payment server 102. At 216, the first issuer server 118 fetches first party details from a Core banking solution (CBS) database. The first party 104 details may include contact information, such as a phone number or an address of the first party 104.

At 218, the first issuer server 118 generates a printable document (such as a PDF document or an image file (e.g. JPEG file)). The printable document may include an address and various other details of the first issuer bank associated with the first party 104 that issued the payment card to the first party 104. It shall be noted that, the address of the first issuer bank may be the address where a head office or a headquarter of the first issuer bank is present. Alternatively, the address of the first issuer bank may be the address where a branch of the first issuer bank is present and which is nearest to a registered address of the first party 104 of the payment card.

At 220, the printable document is sent to the payment server 102. The payment server 102, in turn, makes the printable document available in the application interface 114 on the second party device 110, at 222. In other words, the payment server 102 sends the printable document to the second party device 110 in the lost and found application as an application notification. The first issuer server 118 may also send an instruction to the payment server 102 to print the printable document and paste the printed label on an envelope, inside which the payment card has to be placed and which has to be posted to the address of the first issuer bank mentioned in the printed label. The payment server 102 may send the instruction to the second party device 110 in the lost and found application as an application notification.

Subsequent to receiving the printable document and the instruction in the lost and application, the second party 106 prints the printable document. It shall be noted that the printable document can be printed using a printer that can be connected to the second party device 110 by means of wired connections or wireless connection (such as a Wi-Fi printer). Subsequently, the printed label is pasted on an envelope, inside which the payment card is placed. The envelope is addressed to the address mentioned in the printed label. The first issuer bank receives the payment card within the envelope sent by the second party 106.

It shall be noted that, no postal charge may be incurred by the second party 106 towards the post based on one or more underlying agreements set between the lost and found management application, the issuer banks and other stakeholders. For instance, the postal charge shall be borne by the first issuer bank or alternatively can be reimbursed (e.g., credited) to an issuer account of the second party 106 in the second issuer bank if any upfront cost is paid towards the postal charges by the second party 106. Additionally, in the event of receipt of the envelope by the first issuer bank, a reward may be granted to the second party 106 in terms of reward points. The reward points shall be directly posted to the issuer account of the second party 106 in the second issuer bank. The reward points may be awarded to the second party 106 based on terms and conditions agreed by the first issuer bank, the second issuer bank and other stakeholders in the payment network.

FIGS. 3A and 3B are example representations of pages 300 and 350 of the application interface 114 of the lost and found application. The page 300 as seen in FIG. 3A displays a viewfinder 302 of an image capturing device/camera of the finder device 110. It shall be noted that, opening the lost and found application in the finder device 110 presents an actionable icon (not shown) in the application interface 114. Selection of the actionable icon opens the viewfinder 302 of the camera, allowing the finder to capture a photograph of the payment card of the owner 104.

As also seen in FIG. 3A, the page 300 additionally provides one or more fields where one or more attributes of the payment card can be entered. Attributes, as described earlier refer to the sections or fields of information provided/printed in a document. In this case, the attributes can be a card number, name of issuing authority, a cardholder name, validity of the card, etc. As an example, the page 300 displays three fields, such as, a card number field 304, a first issuer bank field 306 and a cardholder name field 308. The card number field 304 allows the finder 106 to enter the card number of the payment card of the owner 104. The first issuer bank field 306 allows the finder 106 to enter the name of the issuer bank (such as the first issuer bank) printed on the payment card of the owner 104. The cardholder name field 308 allows the finder 106 to enter the name of the cardholder (i.e. the owner 104) printed on the payment card of the owner 104.

Referring now to FIG. 3B, the page 350 displays a printable document 352 including an address 354 of the first issuer bank that is printed on the payment card of the owner 104. It shall be noted that, the address 354 of the first issuer bank may be the address where a head office or the headquarter of the first issuer bank is present. Alternatively, the address 354 of the first issuer bank may be the address where a branch of the first issuer bank is present and which is nearest to the address of the owner 104 of the payment card.

As seen in FIG. 3B, a print icon 356 is provided on right side in the page 350. Selection of the print icon 356 may allow a printer connected to the finder device 110 take a print of the printable document 352 or the address 354 mentioned in the printable document 352. The page 350 further displays an instruction field 358 comprising an instruction to take a print of the address 354 displayed in the printable document 352.

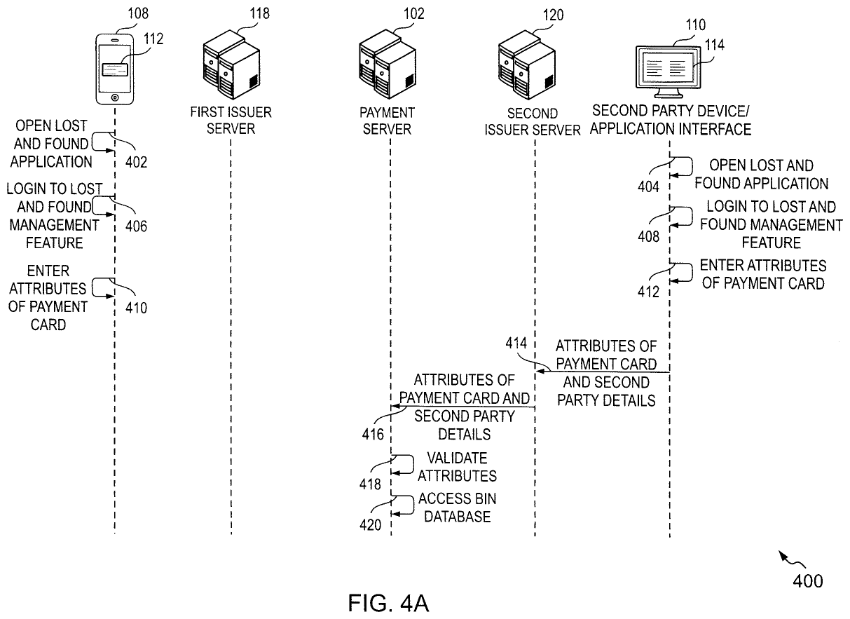

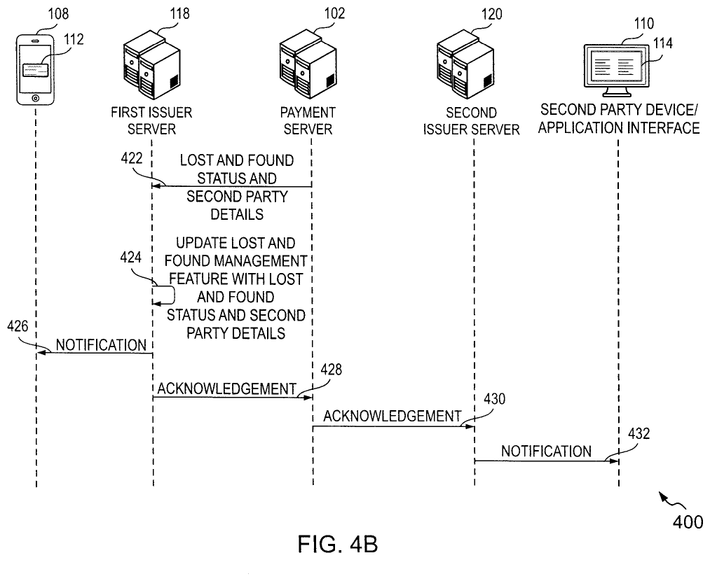

FIGS. 4A and 4B illustrate a simplified schematic flow diagram 400 representing another method of facilitating returning a lost payment card, to an issuer bank/an owner of the lost payment card by the finder 106, in accordance with an example embodiment of the present disclosure. In an example scenario, the owner 104 has lost a payment card including one or more payment cards and identity cards. The owner 104 accesses the lost and found application on the owner device 108 to report the loss. The finder 106, who has found the lost payment card of the owner 104 accesses the lost and found application on the finder device 110 to return the payment card.

The lost and found application may be hosted by the first issuer server 118 and the second issuer server 120. It shall be noted that the lost and found application is downloaded and installed at the first party device 108 and the second party device 110. The owner 104 can download the lost and found application at any instant substantially in advance to losing the payment card or at an instant when the payment card is lost and the owner 104 has to report the loss. Similarly, the finder 106 can download the lost and found application at any instant substantially in advance to finding of the lost payment card of the owner 104. Alternatively, the finder 106 can download the lost and found application at an instant when the lost payment card of the owner 104 is found by him.

Opening or accessing the lost and found application by the owner 104 at the owner device 108 is performed at operation 402. Similarly, the finder 106 opens or accesses the lost and found application downloaded and installed at the finder device 110 as shown at operation 404. It shall be noted that each of the operations 402 and 404 is a one-time operation, and also the operations 402 and 404 need not to necessarily occur in the order as depicted in the flow diagram 400.

It shall further be noted that, the owner 104 and the finder 106 may need to log in/sign in to the lost and found application on their respective devices. For instance, at operation 406, the owner 104 logs in to the lost and found application on the owner device 108. Similarly, at 408, the finder 106 logs in to the lost and found application on the finder device 110. Logging in can be done with an existing account, a social media account or by creating a new account with the application. Details related to sign in are not explained herein for the sake of brevity. Once logged in, the owner 104 and the finder 106 can view the application interfaces 112, 114 on their respective devices.

The owner 104 may report the loss of the payment card or the content of the wallet, such as a payment card, identity documents, etc. In order to report the loss of the payment card, the owner 104 may be instructed to enter one or more attributes of the lost payment card in the application interface 112. At 410, the owner 104 enters at least one attribute of the lost payment card in the application interface 112 on the owner device 108. Similarly, the finder 106 may wish to return the lost payment card. In order to return the lost payment card, the finder 106 may be instructed to enter one or more attributes of the lost payment card in the application interface 112. At 412, the finder 106 enters the one or more attributes of the lost payment card in the application interface 114 on the finder device 110. The finder 106 may further be instructed to enter finder details in the application interface 114 on the owner device 108.

At 414, the one or more attributes of the payment card and the finder details are sent to the second issuer server 120. The one or more attributes may include a card number of the payment card, a first issuer bank name, cardholder/owner name and expiry date/validity of the payment card, among other information. The finder details may include a name of the finder 106, an address of the finder 106 and a phone number of the finder 106, among others.

At 416, the one or more attributes of the payment card and the finder details are sent to the payment server 102. At 418, the one or more attributes are validated. Validation, herein, may refer to determining if the attributes are valid and are associated with a cardholder (such as the owner 104). If an attribute is a photograph of the payment card, then, validation may also refer to identifying whether a photograph of the lost payment card belongs to a payment card and conforms to a pre-defined dimension and format.

At 420, the payment server 102 accesses the BIN database to fetch information on the first issuer bank. The BIN database includes information corresponding to a plurality of banks including the first issuer bank managing the first issuer server 118 and associated with the owner 104 and the second issuer bank managing the second issuer server 120 and associated with the finder 106.

At 422, the lost and found status of the payment card and the finder details are sent to the first issuer server 118 managed by the first issuer bank by the payment server 102. At 424, the first issuer server 118 updates the lost and found application on the owner device 108 with the lost and found status of the payment card and the finder details. As an example, the lost and found application may provide a lost and found management feature (see FIGS. 5A and 5D). The update may be provided in the lost and found management feature. At 426, a notification on the lost and found status (e.g., “card has been found”, “not found”, “in transit”, “to be collected”, “to be dispatched” etc) and the finder details is also sent to the owner device 108 as a text message or an email or in form of an application notification.

At 428, an acknowledgement is sent to the payment server 102 by the first issuer server 118. The acknowledgement may include or refer to acknowledgement in response to the notification sent at 426. At 430, the acknowledgement is sent to the second issuer server 120 by the payment server 102.

At 432, the second issuer server 120 notifies the finder 106 of the acknowledgement by sending a notification in the lost and found application on the finder device 110. Alternatively, notification can be sent as a text message or an email to the finder device 110. The owner 104 may be able to contact the finder 106 on the phone number of the finder 106.

FIGS. 5A-5C are example representations of pages 500, 520 and 540 of the application interface 112 of the lost and found application presented on the owner device 108. The page 500 as seen in FIG. 5A displays actionable icons or menus that redirects the owner 104 to subsequent pages. As an example, an actionable icon 502 redirects the owner 104 to a personal banking page that may ask for the owner's log in credentials to perform banking related activities. An actionable icon 504 redirects the owner 104 to a products page that may provide information to the owner 104 on various banking related products, such as, investment schemes, insurance policies, credit cards, different types of accounts other than savings account, retirement schemes, etc. An actionable icon 506 redirects the owner 104 to a customer care page wherein contact information to reach customer care executives/centers may be provided. An actionable icon 508 redirects the owner 104 to a lost and found management page 520 (shown in FIG. 5B).

The lost and found management page 520, as seen in FIG. 5B, provides one or more fields where one or more attributes of a lost payment card can be entered in order to report loss of the payment card. Attributes, as described earlier refer to the sections or fields of information provided/printed in a document. In this case, the attributes can be a card number, name of issuer bank, a cardholder name, validity of the card, etc. As an example, the page 520 displays three fields, such as, a card number/ID number field 522, a first issuer bank field 524 and a cardholder name field 526. The card number/ID number field 522 allows the owner 104 to enter the card number of the payment card or an ID number of an identity document. The first issuer bank field 524 allows the owner 104 to enter the name of the first issuer bank printed on the payment card of the owner 104. The cardholder name field 526 allows the owner 104 to enter the name of the cardholder (i.e. the owner 104) printed on the payment card of the owner 104. The lost and found management page 520 also provides two actionable icons, a ‘report loss’ icon 528 and a ‘report found’ icon 530. Selection of the icon 528 enables informing the first issuer server 118 and/or the payment server 102 about the lost payment card and at the same instant requesting the first issuer server 118 and/or the payment server 102 to notify the owner 104 with information on a finder (such as the finder 106) who has found the payment card of the owner 104. Similarly, selection of the icon 530 enables informing the second issuer server 120 and/or the payment server 102 that the lost payment card is found and at the same instant requesting the second issuer server 120 and/or the payment server 102 to notify the first issuer server 118 and/or owner 104 with information on the finder 106, who has found the payment card of the owner 104. It shall be noted that the icon 568 is selected by the owner 104 to report loss of the payment card and the icon 530 is selected by the finder 106 to inform that the lost payment card has been found.

Referring now to FIG. 5C, the page 540 displays a text message 542 or an application notification indicating the lost and found status of the payment card and the finder details (e.g. “Your card with number ending 123*****XXX is found by Mr. X”) with finder details. It shall be understood that the text message 542 (or the application notification) may be provided minutes, hours, days or weeks after the owner 104 has reported the loss of the payment card based on when the finder 106 has found the lost payment card and reports the same.

FIGS. 5D-5F are example representations of pages 550, 560 and 580 of the application interface 114 of the lost and found application presented on the finder device 110. The page 550 as seen in FIG. 5D displays actionable icons or menus that redirects the finder 106 to subsequent pages in the application interface 114. As an example, an actionable icon 552 redirects the finder 106 to a personal banking page that may ask for the finder's log in credentials to perform banking related activities. An actionable icon 554 redirects the finder 106 to a products page that may provide information to the finder 106 on various banking related products, such as, investment schemes, insurance policies, credit cards, different types of accounts other than savings account, retirement schemes, etc. An actionable icon 556 redirects the finder 106 to a customer care page wherein contact information to reach customer care executives/centers may be provided. An actionable icon 558 redirects the finder 106 to a lost and found management page 560 (shown in FIG. 5E).

The lost and found management page 560, as seen in FIG. 5E, provides one or more fields where one or more attributes of a lost payment card can be entered in order to report loss of the payment card. Attributes, as described earlier refer to the sections or fields of information provided/printed in a document. In this case, the attributes can be a card number, name of issuer bank, a cardholder name, validity of the card, etc. As an example, the page 560 displays three fields, such as, a card number/ID number field 562, a first issuer bank field 564 and a cardholder name field 566. The card number/ID number field 562 allows the finder 106 to enter the card number of the payment card or an ID number of an identity document. The first issuer bank field 564 allows the finder 106 to enter the name of the first issuer bank printed on the payment card of the owner 104. The cardholder name field 566 allows the finder 106 to enter the name of the cardholder (i.e. the owner 104) printed on the payment card of the owner 104. The lost and found management page 560 also provides an actionable icon, a ‘report loss’ icon 568 selection of which enables informing the first issuer server 118 and/or the payment server 102 about the lost payment card and at the same instant requesting the first issuer server 118 and/or the payment server 102 to notify the owner 104 with information on a finder (such as the finder 106) who has found the payment card of the owner 104. It shall be noted that the icon 568 is selected by the owner 104 to report loss of the payment card. Similarly, selection of an icon 570 enables informing the second issuer server 120 and/or the payment server 102 that the lost payment card is found and at the same instant requesting the second issuer server 120 and/or the payment server 102 to notify the first issuer server 118 and/or owner 104 with information on the finder 106, who has found the payment card of the owner 104. It shall be noted that the icon 570 is selected by the finder 106 to inform that the lost payment card has been found.

Referring now to FIG. 5F, the page 580 displays a text message 582 or an application notification indicating the lost and found status of the payment card and the finder details (e.g. “Mr. Y has been informed about the lost and found card”) with finder details. It shall be understood that the text message 582 (or the application notification) may be provided minutes, hours, days or weeks after the owner 104 has reported the loss of the payment card based on when the finder 106 has found the lost payment card.

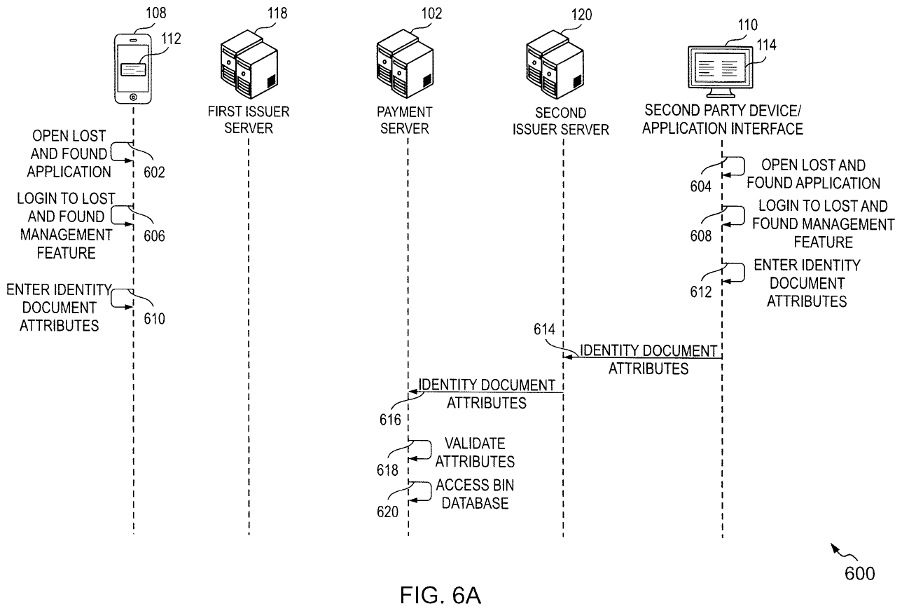

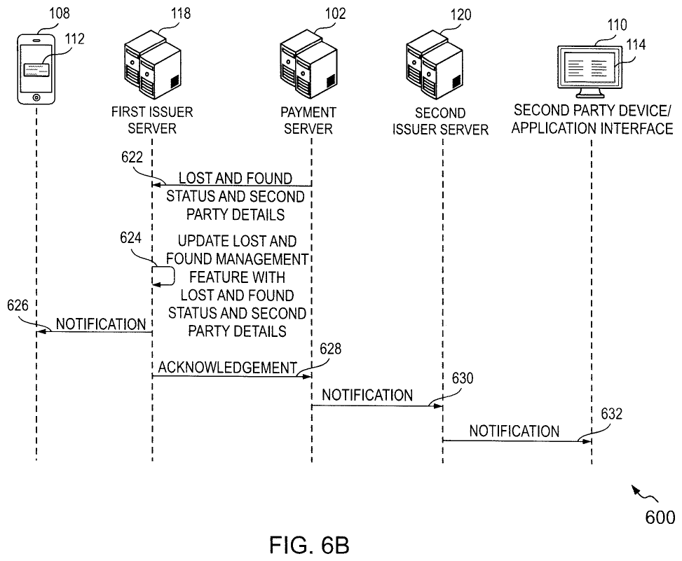

In some example scenarios, the owner 104 may lose an identity document, such as a driving license, passport, a PAN card, etc. Under such circumstances, the finder 106 may have to enter attributes associated with the identity document. FIGS. 6A and 6B illustrate a simplified schematic flow diagram 600 representing another method of facilitating returning a lost identity document, to an issuer bank/an owner of the lost identity document by a finder 106, in accordance with an example embodiment of the present disclosure. The finder 106, who has found the lost identity document of the owner 104 accesses the lost and found application on the finder device 110 to return the wallet and the one or more identity documents to the first issuer bank.

The lost and found application may be hosted by the first issuer server 118 and the second issuer server 120. It shall be noted that the lost and found application is downloaded and installed at the owner device 108 and the finder device 110. The owner 104 can download the lost and found application at any instant substantially in advance to losing the wallet or at an instant when the wallet is lost and the owner 104 has to report the loss. Similarly, the finder 106 can download the lost and found application at any instant substantially in advance to finding of the lost wallet of the owner 104. Alternatively, the finder 106 can download the lost and found application at an instant when the lost wallet of the owner 104 is found.

Opening or accessing the lost and found application by the owner 104 at the owner device 108 is performed at operation 602. Similarly, the finder 106 opens or accesses the lost and found application downloaded and installed at the finder device 110 as shown at operation 604. It shall be noted that the operations 602 and 604 are each a one-time operation. It shall also be noted that, the operations 602 and 604 need not necessarily occur in the order as depicted in the flow diagram 600.

It shall further be noted that, the owner 104 and the finder 106 may need to log in/sign in to the lost and found application on their respective devices. At operation 606, the owner 104 logs in to the lost and found application on the owner device 108. Similarly, at 608, the finder 106 logs in to the lost and found application on the finder device 110. Logging in can be done with an existing account, a social media account or by creating a new account for the application. Details related to sign in is not explained herein for the sake of brevity. Once logged in, the owner 104 can view the application interface 112 and the finder 106 can view the application interface 114 on their respective devices.

The owner 104 may report the loss of the wallet or the contents of the wallet, such as an identity document. In order to report the loss of an identity document, the owner 104 may be instructed to enter one or more attributes of the lost identity document in the application interface 112. At 610, the owner 104 enters the one or more attributes of the lost identity document in the application interface 112 on the owner device 108. Similarly, the finder 106 may wish to return the lost wallet or the contents of the wallet, such as a payment card. In order to return the lost wallet, the finder 106 may be instructed to enter one or more attributes of the lost identity document present inside the wallet in the application interface 114. At 612, the finder 106 enters at least one attribute of the lost identity document in the application interface 114 on the finder device 110. The finder 106 may further be instructed to enter finder details in the application interface 114 on the finder device 110.

At 614, the one or more attributes of the lost identity document and the finder details are sent to the second issuer server 120. The one or more attributes may include an ID number (such as driving license number, PAN card number, etc.) of the lost identity document, an issuing authority (or issuer), owner name and expiry date/validity of the lost identity document, among other information. The finder details may include a name of the finder 106, an address of the finder 106 and a phone number of the finder 106, among others. It shall be noted that one or more identity documents of the owner 104 including the lost identity document may be linked to the first issuer bank and stored in a database associated with the first issuer server 118

At 616, the one or more attributes of the lost identity document and the finder details are sent to the payment server 102. At 618, the one or more attributes are validated. Validation, herein, may refer to determining if the attributes are valid and are associated with a cardholder (such as the owner 104). Validation, may further refer to identifying whether a photograph of the lost identity document belongs to an identity document and conforms to a pre-defined dimension and format.

At 620, the payment server 102 accesses a database such as including but not limited to the BIN database to fetch information on the first issuer bank. The BIN database includes information corresponding to a plurality of banks including the first issuer bank managing the first issuer server 118 and associated with the owner 104 and the second issuer bank managing the second issuer server 120 and associated with the finder 106.

At 622, the lost and found status of the identity document and the finder details are sent to the first issuer server 118 managed by the first issuer bank by the payment server 102. At 624, the first issuer server 118 updates the lost and found application on the owner device 108 with the lost and found status of the identity document and the finder details. As an example, the lost and found application may provide a lost and found management feature (see FIGS. 5A and 5D). The update may be provided in the lost and found management feature. At 626, a notification on the finder details is also sent to the owner device 108 as a text message or an email or an application notification.

At 628, an acknowledgement is sent to the payment server 102 by the first issuer server 118. The acknowledgement may include or refer to acknowledgement in response to the notification sent at 626. At 630, the acknowledgement is sent to the second issuer server 120 by the payment server 102.

At 632, the second issuer server 120 notifies the finder 106 by sending a notification in the lost and found application on the finder device 110. Alternatively, notification can be sent as a text message or an email to the finder device 110. The owner 104 may be able to contact the finder 106 on the phone number of the finder 106.

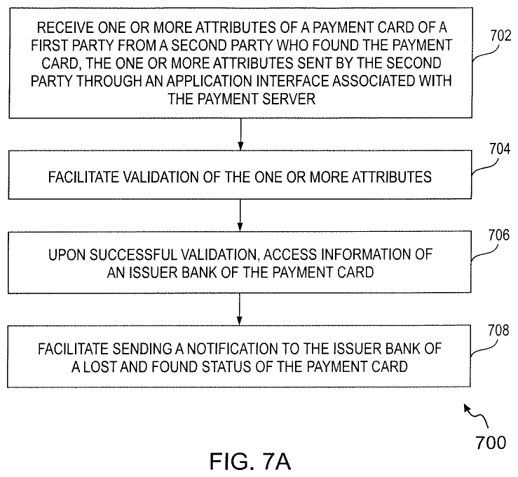

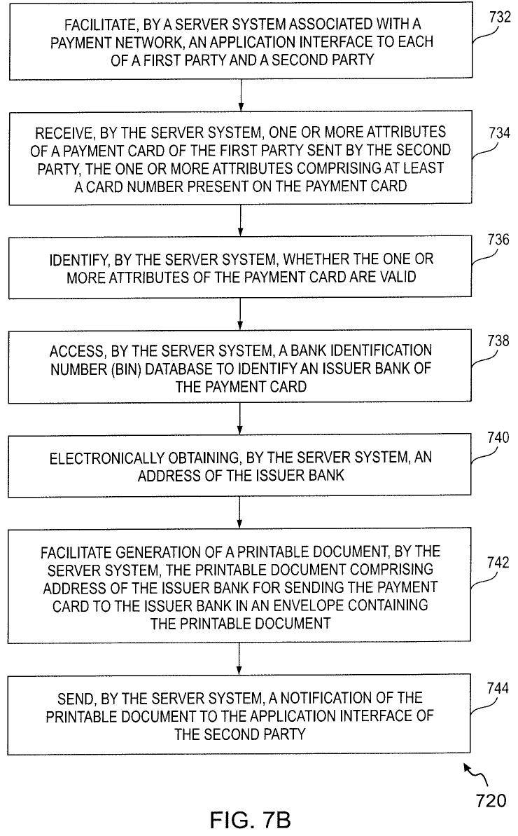

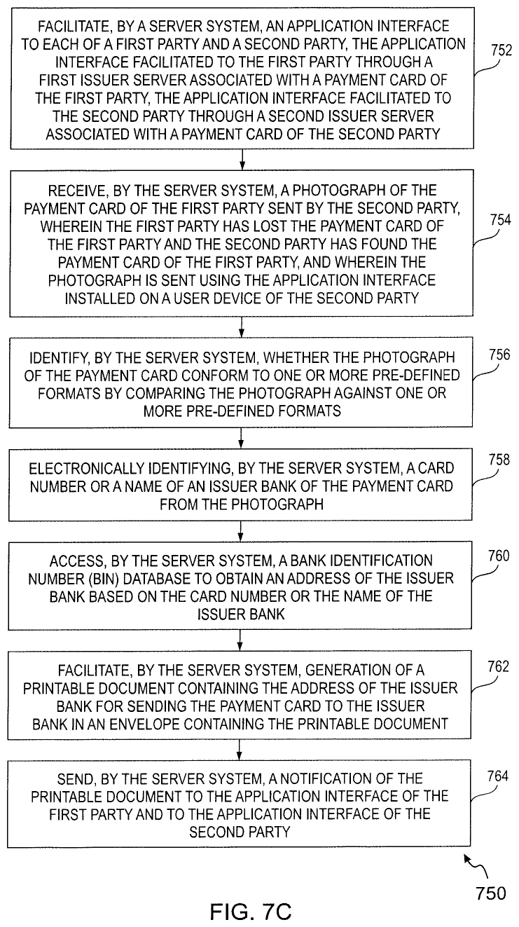

FIG. 7A illustrates a flow diagram of a method 700 for facilitating returning a lost payment card, to an issuer bank/an owner of the lost payment card by a finder 106, in accordance with an example embodiment of the present disclosure. The method 700 depicted in the flow diagram may be executed by a server system, for example, the payment server 102. Operations of the flow diagram 700, and combinations of operation in the flow diagram 700, may be implemented by, for example, hardware, firmware, a processor, circuitry and/or a different device associated with the execution of software that includes one or more computer program instructions. The operations of the method 700 are described herein with help of the payment server 102. It is noted that the operations of the method 700 can be described and/or practiced by using a system other than the payment server 102. The method 700 starts at operation 702.

At 702, one or more attributes of a payment card (or an identity document) of a first party is received from a second party who found the payment card (or the identity document). The one or more attributes are sent by the second party 106 through an application interface associated with the payment server 102.

At 704, validation of the one or more attributes are facilitated. Validation, herein, may refer to determining if the attributes are valid and are associated with a cardholder (such as the owner 104). Further, if the one or more attributes is a photograph of the lost payment card or the identity document, then, validation, may refer to identifying whether the photograph of the lost payment card belongs to a payment card and whether it conforms to a pre-defined dimension and format.

At 706, upon successful validation, information of an issuer bank of the payment card is accessed. The payment server 102 accesses a BIN database to fetch information on the first issuer bank. The BIN database includes information corresponding to a plurality of banks including the first issuer bank and the second issuer bank managing the first issuer server 118 and associated with the owner 104 and the second issuer bank managing the second issuer server 120 and associated with the finder 106.

At 708, the method 700 includes facilitating sending a notification to the issuer bank of a lost and found status of the payment card. It shall be noted that the issuer bank referred to herein is either the first issuer bank or the second issuer bank. The first issuer server 118 updates the lost and found application on the owner device 108 with the finder details. As an example, the lost and found application may provide a lost and found management feature where the update is provided. A notification on the finder details is also sent to the owner device 108 as a text message or an email or an application notification. An acknowledgement in response to the notification is sent to the second issuer server 120 by the payment server 102. The second issuer server 120 notifies the finder 106 of the acknowledgement by sending a notification in the lost and found application on the finder device 110. Alternatively, notification can be sent as a text message or an email to the finder device 110.

FIG. 7B illustrates a flow diagram of a method 720 for facilitating returning a lost payment card, to an issuer bank/an owner of the lost payment card by a finder 106, in accordance with an example embodiment of the present disclosure. The method 720 depicted in the flow diagram may be executed by a server system, for example, the payment server 102. Operations of the method 720, and combinations of operation in the method 720, may be implemented by, for example, hardware, firmware, a processor, circuitry and/or a different device associated with the execution of software that includes one or more computer program instructions. Further, the operations can be executed in an order which is different than what is presented in FIG. 7B. The operations of the method 720 are described herein with help of the payment server 102. It is noted that the operations of the method 720 can be described and/or practiced by using a system other than the payment server 102. The method 720 starts at operation 732.

At operation 732, the method 720 includes facilitating an application interface of a lost and found management application to each of a first party and a second party. For example, the first party (i.e., the owner 104) and the second party (i.e., the finder 106) can install the application interface on their respective devices 108 and 110.

At operation 734, the method 720 includes receiving one or more attributes of the payment card of the owner 104 sent by the finder 106. The one or more attributes include at least a card number present on the payment card. Other examples of the attributes include but not limited to name of cardholder (i.e. the owner), type of card, name of issuer of the payment card, CVV details and validity of the payment card. The finder 106 can send the card number of the payment card to the server system (i.e. the payment server 102) using the application interface in the device 110.

At 736, the method 720 includes identifying whether the one or more attributes of the payment card are valid. For instance, the server system validates whether the card number conforms to any of valid formats of card numbers (e.g., a 16 digits card number).

At 738, the method 720 includes accessing a Bank Identification Number (BIN) database to identify an issuer bank of the payment card. The BIN database includes information corresponding to a plurality of banks including the issuer bank associated with the owner 104.

At 740, the method 720 includes electronically obtaining an address of the issuer bank. In an example, the address of the issuer bank can be fetched from the BIN database.

At 742, the method 720 includes facilitating generation of a printable document, where the printable document contains address of the issuer bank. In an embodiment, the printable document can be printed on a label that can be pasted on an envelope carrying the payment card. The envelope carrying the payment card can be sent to the issuer bank.

At 744, the method 720 includes sending a notification of the printable document to the application interface of the second party, so that the second party is aware that the payment card is ready for dispatch to the issuer bank of the owner 104 of the payment card.

FIG. 7C illustrates a flow diagram of a method 750 for facilitating returning a lost payment card, to an issuer bank/an owner of the lost payment card by a finder 106, in accordance with an example embodiment of the present disclosure. The method 750 depicted in the flow diagram may be executed by a server system, for example, the payment server 102. Operations of the flow diagram 750, and combinations of operation in the flow diagram 750, may be implemented by, for example, hardware, firmware, a processor, circuitry and/or a different device associated with the execution of software that includes one or more computer program instructions. Further, the operations can be executed in an order which is different than what is presented in FIG. 7C. The operations of the method 750 are described herein with help of the payment server 102. It is noted that the operations of the method 750 can be described and/or practiced by using a system other than the payment server 102. The method 750 starts at operation 752.

At operation 752, the method 750 includes facilitating an application interface of a lost and found management application to each of a first party and a second party. For example, the first party (i.e., the owner 104) and the second party (i.e., the finder 106) can install the application interface on their respective devices 108 and 110. The application interface is facilitated to the first party through a first issuer server (e.g., first issuer server 118) associated with a payment card of the first party. The application interface is facilitated to the second party through a second issuer server (e.g., second issuer server 120) associated with a payment card of the second party. For instance, the first party can make a user profile with a first application interface associated with the lost and found application, wherein the first application interface is provided by the first issuer server to the first party. The second party makes a user profile with a second application interface associated with the lost and found application, wherein the second application interface is provided by the second issuer server to the second party. The first application interface and the second application interface are able to communicate with the application interface provided by the server system such as the payment server 102 of the payment network. For instance, once the second party provides any information to the second application interface (e.g., an instance of the application interface hosted by the server system), the second application interface makes the information available to the application interface hosted by the server system.

At operation 754, the method 750 includes receiving, by the server system, a photograph of the payment card of the owner 104 sent by the finder 106. Herein, it is assumed that the owner 104 has lost his payment card and the finder 106 has found the payment card of the owner 104. The finder 106 can send the photograph of the payment card using the application interface installed on a user device of the finder 106. The photograph includes at least a card number present on the payment card. Other information present in the photograph may include but not limited to name of cardholder, type of card, name of issuer of the payment card, CVV details and validity of the payment card. In an example, the finder 106 can send the photograph of the payment card to the server system (i.e. payment server 102) using the application interface in the device 110.

At 756, the method 750 includes identifying whether the photograph of the payment card is valid. For instance, the server system validates whether the photograph conforms to any of one or more pre-defined formats (e.g., a pre-defined shape, size, dimension, color etc.).

At 758, the method 750 includes electronically identifying a card number or a name of an issuer bank of the payment card from the photograph. In an example, the server system may use Optical Character Recognition (OCR) techniques to identify the card number and/or name of the issuer bank from the photograph.

At 760, the method 750 includes accessing a Bank Identification Number (BIN) database to identify the issuer bank of the payment card. The BIN database includes information corresponding to a plurality of banks including the issuer bank associated with the owner 104.

At 762, the method 750 includes facilitating generation of a printable document, where the printable document contains an address of the issuer bank. The address of the issuer bank can be fetched from the BIN database. In an embodiment, the printable document can be printed on a label that can be pasted on an envelope carrying the payment card. The envelope carrying the payment card can be sent to the issuer bank.

At 764, the method 750 includes sending a notification of the printable document to the application interface of the second party, so that the second party is aware that the payment card is ready for dispatch to the issuer bank of the owner 104 of the payment card.

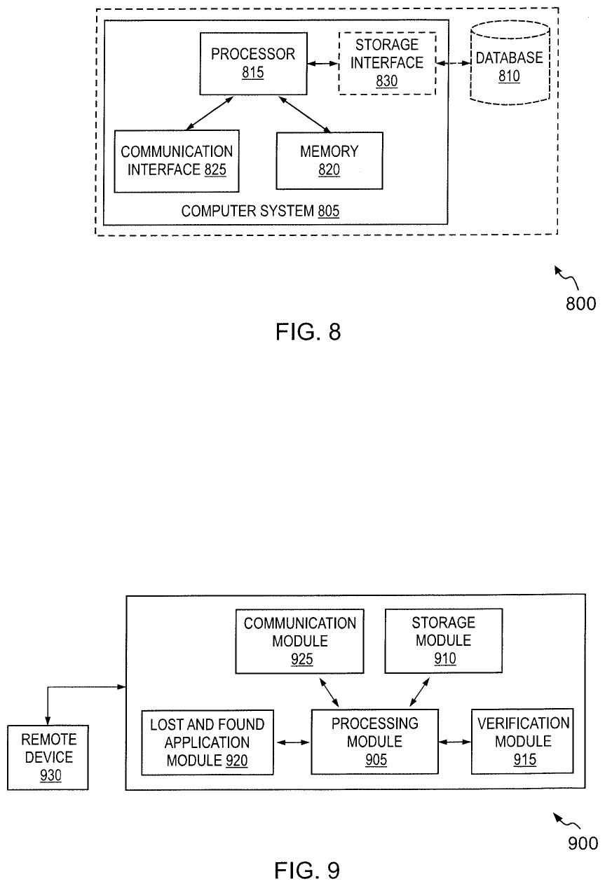

FIG. 8 is a simplified block diagram of a server system 800, in accordance with one embodiment of the present disclosure. The server system 800 is an example of the payment server 102 or the first and second issuer servers 118 and 120 respectively and includes a computer system 805 and one or more databases, such as a database 810.

The computer system 805 includes a processor 815 for executing instructions stored in, for example, but not limited to, a memory 820. The processor 815 may include one or more processing units (e.g., in a multi-core configuration). The processor 815 is operatively coupled to a communication interface 825 such that the computer system 805 can communicate with the first party device 108 and the second party device 110. For example, the communication interface 825 may receive the one or more attributes of a payment card or an identity document from the second party device 110 and the first party device 108.

The processor 815 may also be operatively coupled to the database 810. The database 810 is any computer-operated hardware suitable for storing and/or retrieving data. The database 810 may include multiple storage units such as hard disks and/or solid-state disks in a redundant array of inexpensive disks (RAID) configuration. The database 810 may include, but not limited to, a storage area network (SAN) and/or a network attached storage (NAS) system. In some embodiments, the database 810 is integrated within the computer system 805. For example, computer system 805 may include one or more hard disk drives as the database 810. In other embodiments, the database 810 is external to the computer system 805 and may be accessed by the computer system 805 using a storage interface 830. The storage interface 830 is any component capable of providing the processor 815 with access to the database 810. The storage interface 830 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 815 with access to the database 810.

FIG. 9 is a simplified block diagram of an issuer server 900 used for facilitating returning a lost payment card, to an issuer bank/an owner of the lost payment card by a finder such as the finder 106, in accordance with one embodiment of the present disclosure. The issuer server 900 is an example of the first issuer server 118 or the second issuer server 120 of FIG. 1. The issuer server 900 is associated with an issuer bank/issuer, in which a customer (such as the first party 104 and/or the second party 106) may have an account, which provides a payment card. The issuer server 900 includes a processing module 905 operatively coupled to a storage module 910, a verification module 915, a lost and found application module 920 and a communication module 925. The components of the issuer server 900 provided herein may not be exhaustive and that the issuer server 900 may include more or fewer components than that of depicted in FIG. 9. Further, two or more components may be embodied in one single component, and/or one component may be configured using multiple sub-components to achieve the desired functionalities. Some components of the issuer server 900 may be configured using hardware elements, software elements, firmware elements and/or a combination thereof.

The storage module 910 is configured to store machine executable instructions to be accessed by the processing module 905. Additionally, the storage module 910 stores information related to, contact information of the customer, bank account number, availability of funds in the account, payment card details, attributes of payment cards, and/or the like. This information is retrieved by the processing module 905 may be validated by the verification module 915. The verification module 915 may include one or more predefined rule sets using which the validation can be performed. The verification module 915 validates the one or more attributes of the payment card/identity document associated with the first party 104.

The processing module 905 is configured to communicate with one or more remote devices such as a remote device 930 using the communication module 925 over a network such as the network 116 of FIG. 1. The examples of the remote device 930 include the payment server 102, the first party device 108 and the second party device 110. The communication module 925 is capable of facilitating such operative communication with the remote devices and cloud servers using API (Application Program Interface) calls. The communication module 925 is configured to receive one or more attributes from the payment server 102 via the network 116. The communication module 925 is configured to send notification or acknowledgement to the payment server 102 via the payment network 116.

The processing module 905 is further configured to receive data from and provide instructions to the lost and found application module 920. The lost and found application module 920 receives the one or more attributes of a payment card or an identity document from the first party 104 and the second party 106. The lost and found application module 920 is in operative communication with the payment server 102. The lost and found application module 920 further manages notifications to be sent to the first party 104 and the second party 106.

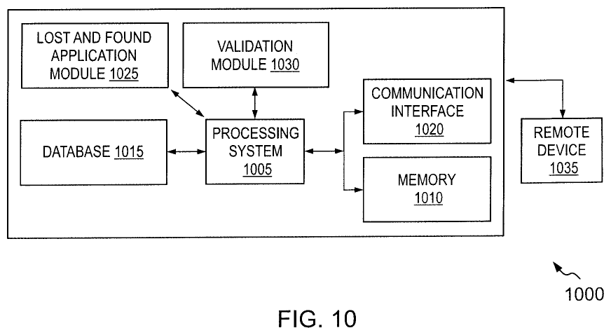

FIG. 10 is a simplified block diagram of a payment server 1000 used for facilitating returning a lost payment card, to an issuer bank/an owner of the lost payment card by a finder such as the finder 106, in accordance with one embodiment of the present disclosure. The payment server 1000 may correspond to the payment server 102 of FIG. 1. The payment server 1000 includes a processing system 1005 configured to extract programming instructions from a memory 1010 to provide various features of the present disclosure. The components of the payment server 1000 provided herein may not be exhaustive and that the payment server 1000 may include more or fewer components than that of depicted in FIG. 10. Further, two or more components may be embodied in one single component, and/or one component may be configured using multiple sub-components to achieve the desired functionalities. Some components of the payment server 1000 may be configured using hardware elements, software elements, firmware elements and/or a combination thereof.

The payment server 1000 comprises a lost and found application module 1025 (an example of the lost and found management module 920). The processing system 1005, in combination with the lost and found application module 1025, receives one or more attributes of a payment card or an identity document of the first party 104 from a remote device 1035 such as the issuer server 900, the first party device 108 and/or the second party device 110, via the communication interface 1020. The communication may be achieved through API calls, without loss of generality. A database 1015 stores details such as Issuer ID, country code, first party details, second party details and information on payment cards and identity documents of the first party 104 and/or the second party 106, among others. Upon receiving the one or more attributes, the payment server 1000 may perform a lookup into the database 1015 to identify the associated first party 104.

The first party details, second party details and information on payment cards and identity documents of the first party 104 and/or the second party 106, etc., are validated using a validation module 1030. The validation module 1030 may include one or more predefined rule sets using which validation is processed. Further, upon successful validation, the validation module 1030 sends the attributes of the payment card or the identity document associated with the first party 104 to the issuer server 900.

The processing system 1005 is further configured to notify the remote device 1035 of the lost and found status of a payment card or an identity card via the communication interface 1020. The processing system 1005 is further configured to receive data from and provide instructions to the lost and found application module 1025. The lost and found application module 1025 receives the one or more attributes of a payment card or an identity document from the first party 104 and the second party 106. The lost and found application module 1025 is in operative communication with the first issuer server 118 and the second issuer server 120. The lost and found application module 1025 further manages notifications to be sent to the first party 104 and the second party 106.

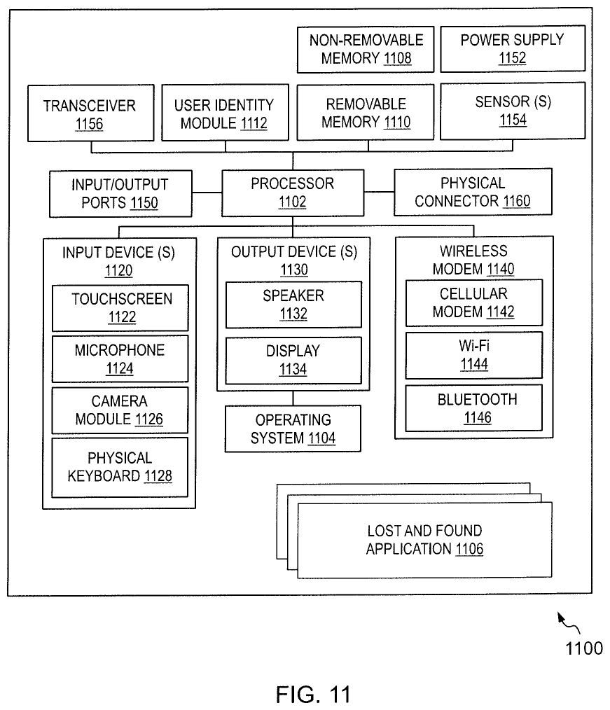

FIG. 11 shows simplified block diagram of a user device, such as the first party device 108 and the second party device 110 of FIG. 1. The user device 1100, for example, can be a desktop computer or a mobile phone capable of implementing the various embodiments of the present disclosure. The user device 1100 is depicted to include a lost and found application 1106.

It should be understood that the user device 1100 as illustrated and hereinafter described is merely illustrative of one type of device and should not be taken to limit the scope of the embodiments. As such, it should be appreciated that at least some of the components described below in connection with that the user device 1100 may be optional and thus in an example embodiment may include more, less or different components than those described in connection with the example embodiment of the FIG. 11. As such, among other examples, the user device 1100 could be any of an electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1100 includes a controller or a processor 1102 (e.g., a signal processor, microprocessor, ASIC, or other control and processing logic circuitry) for performing such tasks as signal coding, data processing, image processing, input/output processing, power control, and/or other functions. An operating system 1104 controls the allocation and usage of the components of the user device 1100 and support for one or more applications programs (see, lost and found application 1106), that implements one or more of the innovative features described herein. The lost and found application 1106 may include common mobile computing applications (e.g., telephony applications, email applications, calendars, contact managers, web browsers, messaging applications such as USSD messaging or SMS messaging or SIM Tool Kit (STK) application) or any other computing application.

The illustrated user device 1100 includes one or more memory components, for example, a non-removable memory 1108 and/or a removable memory 1110. The non-removable memory 1108 and/or the removable memory 1110 may be collectively known as database in an embodiment. The non-removable memory 1108 can include RAM, ROM, flash memory, a hard disk, or other well-known memory storage technologies. The removable memory 1110 can include flash memory, smart cards, or a Subscriber Identity Module (SIM). The one or more memory components can be used for storing data and/or code for running the operating system 1104 and the lost and found applications 1106. The user device 1100 may further include a user identity module (UIM) 1112. The UIM 1112 may be a memory device having a processor built in. The UIM 1112 may include, for example, a subscriber identity module (SIM), a universal integrated circuit card (UICC), a universal subscriber identity module (USIM), a removable user identity module (R-UIM), or any other smart card. The UIM 1112 typically stores information elements related to a mobile subscriber. The UIM 1112 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1100 can support one or more input devices 1120 and one or more output devices 1130. Examples of the input devices 1120 may include, but are not limited to, a touch screen/a display screen 1122 (e.g., capable of capturing finger tap inputs, finger gesture inputs, multi-finger tap inputs, multi-finger gesture inputs, or keystroke inputs from a virtual keyboard or keypad), a microphone 1124 (e.g., capable of capturing voice input), a camera module 1126 (e.g., capable of capturing still picture images and/or video images) and a physical keyboard 1128. Examples of the output devices 1130 may include, but are not limited to a speaker 1132 and a display 1134. Other possible output devices can include piezoelectric or other haptic output devices. Some devices can serve more than one input/output function. For example, the touch screen 1122 and the display 1134 can be combined into a single input/output device.

A wireless modem 1140 can be coupled to one or more antennas (not shown in the FIG. 11) and can support two-way communications between the processor 1102 and external devices, as is well understood in the art. The wireless modem 1140 is shown generically and can include, for example, a cellular modem 1142 for communicating at long range with the mobile communication network, a Wi-Fi compatible modem 1144 for communicating at short range with an external Bluetooth-equipped device or a local wireless data network or router, and/or a Bluetooth-compatible modem 1146. The wireless modem 1140 is typically configured for communication with one or more cellular networks, such as a GSM network for data and voice communications within a single cellular network, between cellular networks, or between the user device 1100 and a public switched telephone network (PSTN).

The user device 1100 can further include one or more input/output ports 1150 for establishing connection with peripheral devices including a power supply 1152, one or more sensors 1154 for example, an accelerometer, a gyroscope, a compass, or an infrared proximity sensor for detecting the orientation or motion of the user device 1100 and biometric sensors for scanning biometric identity of an authorized user, a transceiver 1156 (for wirelessly transmitting analog or digital signals) and/or a physical connector 1160, which can be a USB port, IEEE 1294 (FireWire) port, and/or RS-232 port. The illustrated components are not required or all-inclusive, as any of the components shown can be deleted and other components can be added.

The disclosed methods with reference to any of the FIGS. 1 to 11 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 800 (e.g., the payment server 102) various components such as the computer system 805 and the database 810 may be enabled using software and/or using transistors, logic gates, and electrical circuits (for example, integrated circuit circuitry such as ASIC circuitry).

Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Without in any way limiting the scope, interpretation, or application of the claims appearing below, a technical effect of one or more of the example embodiments disclosed herein is to provide computer implemented methods and server systems for facilitating returning of lost items to an owner or an issuer bank of the owner by a finder. The system provides an application as a platform for reporting the loss of a wallet or a payment card or an identity document present in the wallet by an owner of the wallet. The application further enables provision of one or more attributes of a payment card or an identity document present in the wallet by an owner of the wallet by a finder of the lost wallet. Embodiments further provide sending a printable document including an address of an issuer bank associated with the lost payment card to the finder such that the finder can return the lost payment card to the address provided. Embodiments further provide techniques for notifying lost and found status of the payment card or the identity document to the issuer bank. As such inconvenience related to a reporting loss of payment card or an identity document and returning the payment card or the identity document to its owner associated with existing solutions is reduced.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A lost and found management method for payment cards, the method comprising:
receiving, by a server system associated with a payment network, one or more attributes of a payment card of a first party from a second party who found the payment card, the one or more attributes sent by the second party through an application interface associated with the server system;
facilitating validation, by the server system, of the one or more attributes;
upon successful validation, accessing, by the server system, information of an issuer bank of the payment card; and
facilitating sending, by the server system, a notification to the issuer bank of a lost and found status of the payment card.

2. The method as claimed in claim 1, further comprising:
receiving second party details from the second party who found the payment card through the application interface associated with the server system.

3. The method as claimed in claim 1, further comprising:
receiving a report of loss of the payment card from the first party through the application interface associated with the server system, the report of loss comprising providing at least one attribute of the payment card.

4. The method as claimed in claim 1, wherein the server system is a payment server and the application interface is hosted by the payment server, wherein the one or more attributes comprise a photograph of the payment card.

5. The method as claimed in claim 1, wherein the server system is a payment server and wherein accessing the information of the issuer bank comprises fetching the information of the issuer bank from a bank identification number (BIN) database.

6. The method as claimed in claim 1, wherein the server system is a payment server and wherein facilitating sending the notification comprises sending the notification to at least a first issuer server associated with the first party and a second issuer server associated with the second party.

7. The method as claimed in claim 1, wherein facilitating sending the notification further comprises sending an acknowledgement of the notification to a second party device.

8. The method as claimed in claim 1, wherein the server system is a first issuer server and the application interface is hosted by the first issuer server and wherein the method further comprises:
receiving information corresponding to the payment card from the first party through the application interface; and
fetching first party details from a core banking solution (CBS) database, the first party details comprising contact information of the first party.

9. The method as claimed in claim 1, wherein the server system is a first issuer server and the application interface is hosted by the first issuer server, wherein facilitating sending the notification comprises updating the application interface with the lost and found status of the payment card and second party details.

10. The method as claimed in claim 1, further comprising, facilitating, by the server system, sending a printable document to the application interface in a second party device, the printable document comprising a postal address of the issuer bank of the payment card.

11. The method as claimed in claim 10, further comprising, facilitating, by the server system rewarding the second party with reward points upon posting the payment card to the postal address of the issuer bank of the payment card.

12. A lost and found management system in a server system, comprising:
a memory comprising stored instructions; and
a processor configured to execute the stored instructions to cause the lost and found management system to perform at least:
receiving one or more attributes of an identity document of a first party from a second party who found the identity document, the one or more attributes sent by the second party through an application interface associated with the server system;
facilitating validation of the one or more attributes;
upon successful validation, accessing information of an issuer of the identity document; and
facilitating sending a notification to the issuer of a lost and found status of the identity document.

13. The system as claimed in claim 12, wherein the processor is further configured to receive second party details from the second party who found the identity document through the application interface associated with the server system.

14. The system as claimed in claim 12, wherein the server system is a payment server and the application interface is hosted by the payment server, and wherein the one or more attributes comprise a photograph of the identity document.

15. The system as claimed in claim 12, wherein the identity document is a payment card, the server system is a payment server, and wherein for accessing the information of the issuer bank, the payment server is configured to fetch the information of the issuer bank from a bank identification number (BIN) database.

16. The system as claimed in claim 12, wherein identity document is a payment card, the server system is a payment server, and wherein for facilitating sending the notification, the payment server is configured to send the notification to at least a first issuer server associated with the first party and a second issuer server associated with the second party.

17. The system as claimed in claim 12, wherein the identity document is a payment card, the server system is a first issuer server and the application interface is hosted by the first issuer server, and wherein the system is further caused to perform at least:
receiving information corresponding to the payment card from the first party through the application interface; and
fetching first party details from a core banking solution (CBS) database, the first party details comprising contact information of the first party.

18. The system as claimed in claim 12, wherein the identity document is a payment card, the server system is a first issuer server and the application interface is hosted by the first issuer server, wherein for facilitating sending the notification, the first issuer server is configured to update the application interface with the lost and found status of the payment card and second party details.

19. The system as claimed in claim 12, wherein the system is further caused to send a printable document to the application interface in the second party device, the printable document comprising a postal address of the issuer of the identity document.

20. A lost and found management method for payment cards, the method comprising:
facilitating, by a server system, an application interface to each of a first party and a second party, the application interface facilitated to the first party through a first issuer server associated with a payment card of the first party, the application interface facilitated to the second party through a second issuer server associated with a payment card of the second party;
receiving, by the server system, a photograph of the payment card of the first party sent by the second party, wherein the first party has lost the payment card of the first party and the second party has found the payment card of the first party, and wherein the photograph is sent using the application interface installed on a user device of the second party;
identifying, by the server system, whether the photograph of the payment card conform to one or more pre-defined formats by comparing the photograph against the one or more pre-defined formats;
electronically identifying, by the server system, a card number or a name of an issuer bank of the payment card from the photograph;
accessing, by the server system, a Bank Identification Number (BIN) database to obtain an address of the issuer bank based on the card number or the name of the issuer bank;
facilitating, by the server system, generation of a printable document containing the address of the issuer bank for sending the payment card to the issuer bank in an envelope containing the printable document; and
sending, by the server system, a notification of the printable document to the application interface of the first party and to the application interface of the second party.
